(19) United States
(12) Patent Application Publication
(10) Pub. No.: US 2017/0240236 A1
(43) Pub. Date: Aug. 24, 2017

(54) UNIVERSAL BICYCLE MOUNTING APPARATUS TO SUPPORT AN INFANT SEAT

(71) Applicant: EDGAR SABLAN ENRIQUEZ, LAS VEGAS, NV (US)

(72) Inventor: EDGAR SABLAN ENRIQUEZ, LAS VEGAS, NV (US)

(21) Appl. No.: 15/438,379

(22) Filed: Feb. 21, 2017

Related U.S. Application Data
(60) Provisional application No. 62/296,873, filed on Feb. 18, 2016.

(51) Int. Cl. B62J 11/00; A47D 1/10; A47D 1/00; A47C 7/14; A47C 7/00

(52) U.S. Cl. CPC B62J 11/00; A47C 7/14; A47C 7/002; A47D 1/006; A47D 1/10; B60R 2011/004

(57) ABSTRACT

A universal bicycle mounting apparatus that secures an infant car seat to a bicycle frame is provided. The mounting apparatus includes a base frame coupled to the frame of the bicycle and having a plurality of legs, the plurality of legs having a pair of front legs and a pair of rear legs, each front leg of the pair of front legs coupled to one of the pair of rear legs at a junction, each front leg in the pair of front legs having a front spring coupled thereto, each rear leg in the pair of rear legs having a rear spring coupled thereto, and a cradle designed to support the infant car seat and coupled to the front springs of the front legs and the rear springs of the rear legs.

### RELATED APPLICATION

The application claims priority to provisional patent application U.S. Ser. No. 62/296,873 filed on Feb. 18, 2016, the entire contents of which is herein incorporated by reference.

### BACKGROUND

The embodiments herein relate generally to mounting devices for securing an infant car seat to a bicycle.

Infant/child car seats are secured to a vehicle's seat when traveling with a baby. In many instances, parents or caretakers ride bicycles as a primary means of transportation and/or for recreational activities. Therefore, it is desirable for these individuals to be able to secure existing infant/child car seats to any bicycle.

Several existing infant car seat mounts exist in the industry such as Steco's Baby Mee child seat support. However, these mounts require the user to purchase specialized mounting components such as a rear rack from a particular manufacturer and require bulky or impractical equipment. This is not cost effective and impractical because the child seat support mounting components are not designed for use with all bicycle types and manufacturers. In addition, these child seat supports are limited in their ability to absorb bumps in the road and provide a comfortable ride for the child occupant seated therein.

As such, there is a need in the industry for a universal bicycle mounting apparatus for securing an infant/child seat to a bicycle that overcomes the limitations of the prior art, which is configured for use with all types and manufacturers of bicycles. There is a further need for the universal bicycle mounting apparatus to provide enhanced comfort to the child occupant when the bicycle travels along a bumpy road surface.

### SUMMARY

A universal bicycle mounting apparatus configured to secure an infant car seat to a frame of a bicycle is provided. The mounting apparatus is configured to provide enhanced stability and comfort to an occupant of the car seat when the bicycle travels along an uneven ground surface. The mounting apparatus comprises a base frame coupled to the frame of the bicycle and comprising a plurality of legs, the plurality of legs comprising a pair of front legs and a pair of rear legs, each front leg of the pair of front legs coupled to one of the pair of rear legs at a junction, each front leg in the pair of front legs comprising a front spring coupled thereto, each rear leg in the pair of rear legs comprising a rear spring coupled thereto, and a cradle configured to support the infant car seat and coupled to the front springs of the front legs and the rear springs of the rear legs, the cradle comprising a bar member bent in a pathway that forms an opening to receive a portion of the infant car seat therethrough, wherein the pair of front springs and the pair of rear springs absorb shock to enhance comfort of the occupant situated in the car seat.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the bicycle mounting apparatus shown in use;

FIG. 2 depicts a perspective view of certain embodiments of the bicycle mounting apparatus;

FIG. 3 depicts a perspective view of certain embodiments of the bicycle mounting apparatus illustrating front spring 40;

FIG. 4 depicts a section view of certain embodiments of the bicycle mounting apparatus taken along line 4-4 in FIG. 3;

FIG. 5 depicts a perspective view of certain embodiments of the bicycle mounting apparatus illustrating rear spring 42;

FIG. 6 depicts a section view of certain embodiments of the bicycle mounting apparatus taken along line 6-6 in FIG. 5;

FIG. 7 depicts a section view of certain embodiments of the bicycle mounting apparatus taken along line 7-7 in FIG. 2;

FIG. 8 depicts a perspective view of certain embodiments of the bicycle mounting apparatus;

FIG. 9 depicts a perspective view of certain embodiments of the bicycle mounting apparatus;

FIG. 10 depicts a section view of certain embodiments of the bicycle mounting apparatus taken along line 10-10 in FIG. 1;

FIG. 11 depicts a perspective view of an alternative embodiment of the bicycle mounting apparatus; and

FIG. 12 depicts a perspective view of certain embodiments of the bicycle mounting apparatus.

### DETAILED DESCRIPTION OF CERTAIN EMBODIMENTS

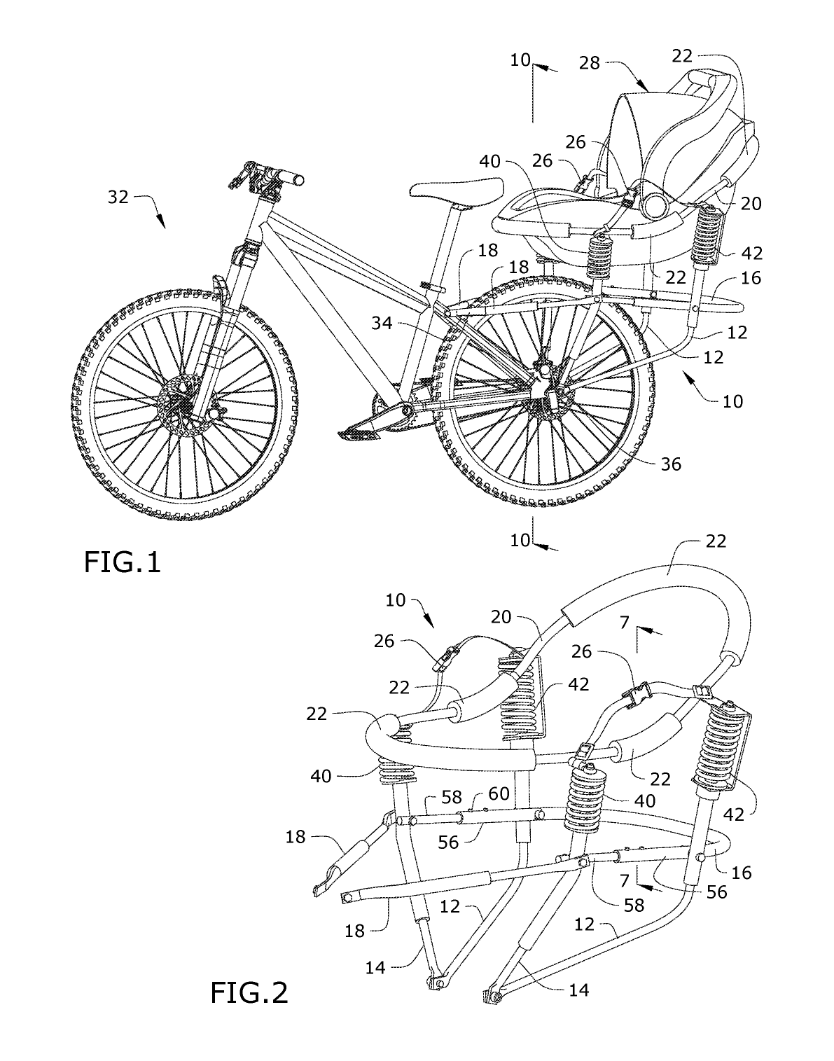

As depicted in FIGS. 1-2, mounting apparatus 10 is configured to secure infant car seat 28 to bike 32. Infant car seat 28 is an existing car seat known in the field generally designed to transport infant children between the ages of 6-12 months with a weight up to 32 lbs. Mounting apparatus 10 is designed to be a universal assembly configured for use with different types of bikes. When in use, mounting apparatus 10 provides enhanced comfort to an occupant of infant car seat 28 as bike 28 travels over uneven terrain.

In certain embodiments, mounting apparatus 10 generally comprises a frame comprising front legs 14, rear legs 12, forward brackets 18, U-bracket 16, front springs 40, rear springs 42 and cradle 20. A pair of front legs 14 and a pair of rear legs 12 are coupled to U-bracket 16 by mechanical fasteners such as bolts, nuts, or the like. In a preferred embodiment, a first pair comprising front leg 14 and rear leg 12 is coupled to a left side of U-bracket 16 and a second pair comprising front leg 14 and rear leg 12 is coupled to a right side of U-bracket 16. As depicted in FIGS. 2 and 7, U-bracket 16 comprises rear outer U-bracket member 56 mechanically coupled to rear inner U-bracket member 58 by fasteners 60. U-bracket 16 enhances the stability and structural integrity of mounting apparatus 10. In addition, U-bracket 16 minimizes motion and/or swaying of mounting apparatus 10 and infant car seat 28.

As depicted in FIGS. 1-2, a pair of forward brackets 18 is coupled to the pair of front legs 14 and bike frame 34 by mechanical fasteners such as bolts, nuts, or the like. In one embodiment, clamps (not shown) may be used to secure forward brackets 18 to bike frame 34 instead. The bottom ends of each connected pair of front leg 14 and rear leg 12 are connected at a lower junction. This lower junction of each connected pair of front leg 14 and rear leg 12 is coupled to a rear dropout of bike 32 proximate wheel hub 36 as shown in FIG. 12.

Front springs 40 are coupled to the top ends of front legs 14 and rear springs 42 are coupled to the top ends of rear legs 12. In one embodiment, each front spring 40 comprises a spring size of approximately 1⅜×1⅞ inches and each rear spring 42 comprises a spring size of approximately 1^{1/4}×3 inches. Therefore, each rear spring 42 comprises a natural height that is greater than a natural height of each front spring 40.

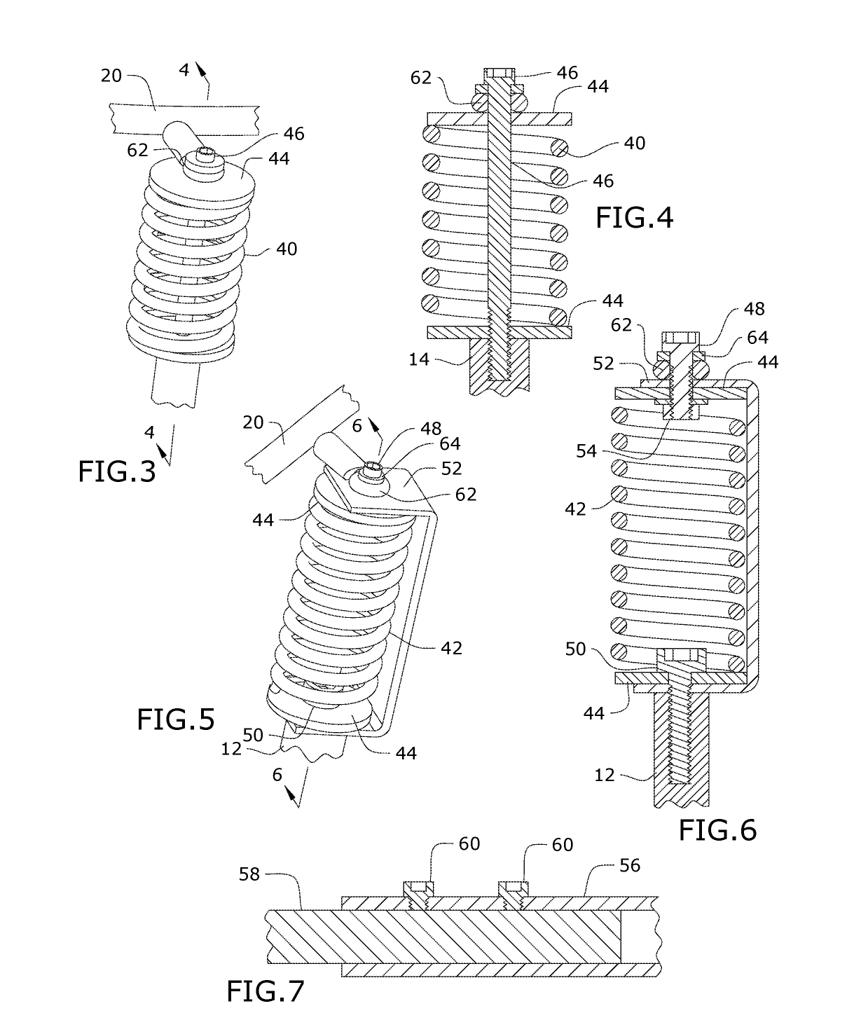

As depicted in FIGS. 2-4, each front spring 40 is coupled to cradle 20 by eyebolt and spacer assembly 62 and coupled to front leg 14 by front spring bolt 46. Each front spring 40 comprises a pair of spring washers 44 welded to the top and bottom ends of front spring 40. Front spring bolt 46 is disposed vertically through an eye portion of eyebolt and spacer assembly 62, the interior space within front spring 40, spring washers 44 and a portion of front leg 14. A bolt portion of eyebolt and spacer assembly 62 is coupled to cradle 20 and secured in place by a nut (not shown).

As depicted in FIGS. 2 and 5-6, each rear spring 42 comprises a pair of spring washers 44 welded to the top and bottom ends of rear spring 42. In one embodiment, each rear spring 42 is coupled to cradle 20 by eyebolt and spacer assembly 62, upper rear spring bolt 48, top washer 64 and rear spring nut 54. More specifically, upper rear spring bolt 48 is disposed vertically through top washer 64, an eye portion of eyebolt and spacer assembly 62 and spring washer 44. Upper rear spring bolt 48 is secured in place by rear spring nut 54. A bolt portion of eyebolt and spacer assembly 62 is coupled to cradle 20 and secured in place by a nut (not shown). Each rear spring 42 is coupled to rear leg 12 by lower rear spring bolt 50, which is disposed vertically through spring washer 44 and rear leg 12.

In one embodiment, strap 52 extends along the side of rear spring 42. The top end of strap 52 is disposed between eyebolt and spacer assembly 62 and spring washer 44. The bottom end of strap 52 is disposed between rear leg 12 and spring washer 44. Strap 52 is preferably made from nylon and is configured to prevent rear spring 42 from being hyperextended during use.

As depicted in FIGS. 1-2, cradle 20 is a bar member bent in a pathway that forms an opening to receive a portion of infant car seat 28. In one embodiment, a plurality of tubular cushion members 22 are disposed around cradle 20. In one embodiment, a pair of fastening belts 26 are coupled to eyebolt and spacer assemblies 62 and configured to secure infant car seat 28 in place when disposed within cradle 20. Each fastening belt 26 comprises a belt with buckle components and an adjustment component to adjust the length of the belt.

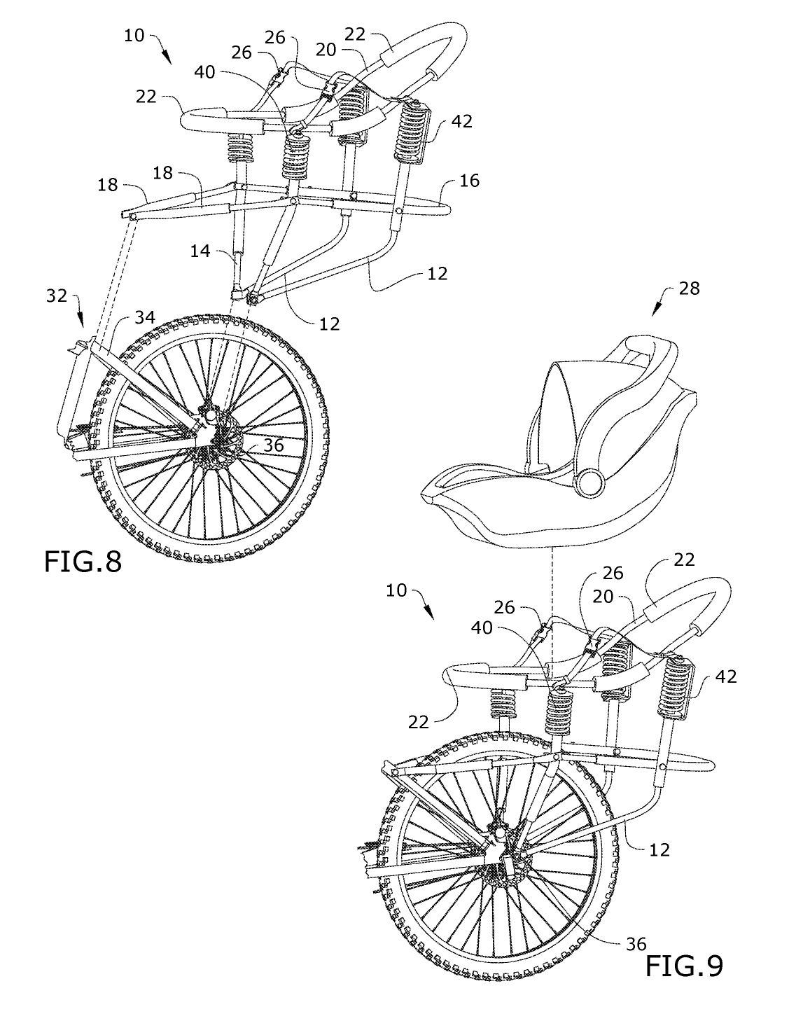

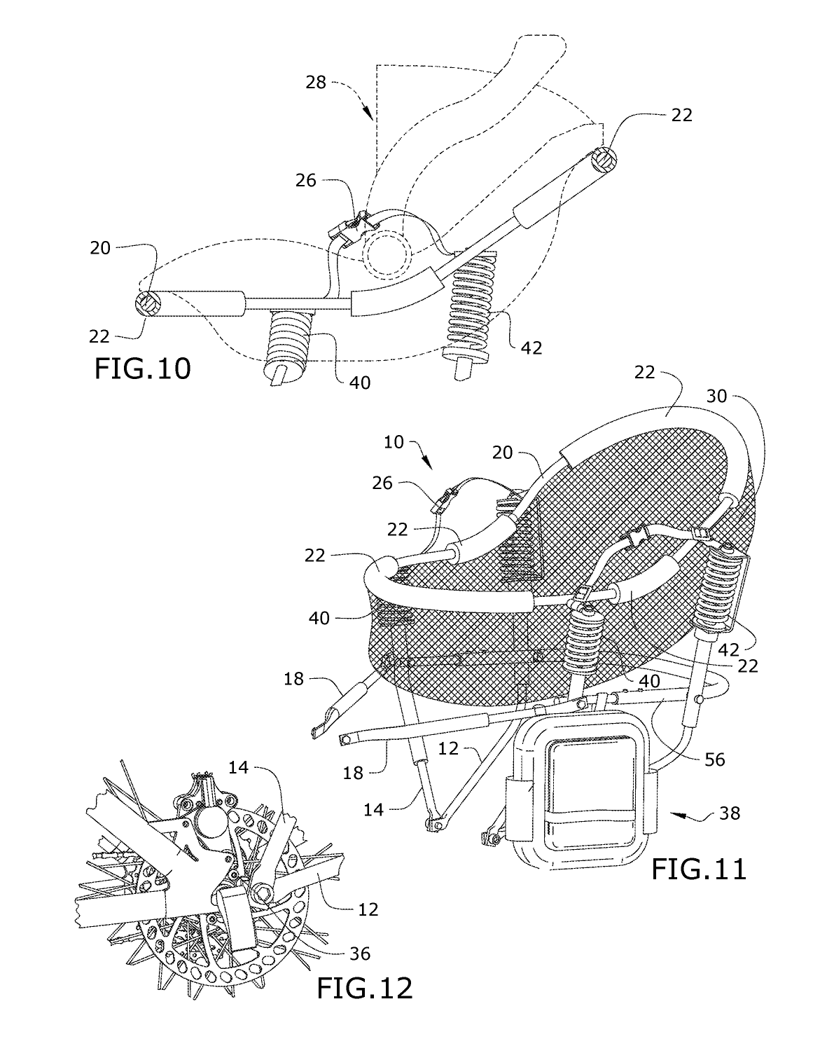

In operation, mounting apparatus 10 is coupled to bike 32 as depicted in FIGS. 1 and 8. Specifically, forward brackets 18 are coupled to bike frame 34 and front and rear legs 12, 14 are coupled to rear dropouts of bike frame 34. As depicted in FIGS. 1 and 9-10, infant car seat 28 is disposed on cradle 20 and secured in place by fastening belts 26, which may be disposed around the handle of infant car seat 28. An occupant (not shown) is secured within infant car seat 28. Front and rear springs 40, 42 absorb shock as bike 32 travels over bumps and/or uneven surfaces on the ground.

As depicted in FIG. 11, net 30 and bag 38 may be used with mounting apparatus 10 in an alternative embodiment. Net 30 is a mesh member that is coupled to cradle 20 by clip fasteners (not shown) or alternative fastening components. Net 30 is configured to store a plurality of accessories. Net 30 may be used regardless of whether mounting apparatus 10 is supporting infant car seat 28. Similarly, bag 38 may be coupled to any member of mounting apparatus 10 by clips, loop straps, or other fasteners. Bag 38 is configured to securely store any variety of accessories including, but not limited to, feeding bottles, diapers, wipes, or the like.

It shall be appreciated that the components of mounting apparatus 10 described in several embodiments herein may comprise any alternative known materials in the field and be of any color, size and/or dimensions. It shall be appreciated that the components of mounting apparatus 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A universal bicycle mounting apparatus configured to secure an infant car seat to a frame of a bicycle, the mounting apparatus configured to provide enhanced stability and comfort to an occupant of the car seat when the bicycle travels along an uneven ground surface, the mounting apparatus comprising:
a base frame coupled to the frame of the bicycle and comprising a plurality of legs, the plurality of legs comprising a pair of front legs and a pair of rear legs, each front leg of the pair of front legs coupled to one of the pair of rear legs at a junction, each front leg in the pair of front legs comprising a front spring coupled thereto, each rear leg in the pair of rear legs comprising a rear spring coupled thereto; and
a cradle configured to support the infant car seat and coupled to the front springs of the front legs and the rear springs of the rear legs, the cradle comprising a bar member bent in a pathway that forms an opening to receive a portion of the infant car seat therethrough, wherein the pair of front springs and the pair of rear springs absorb shock to enhance comfort of the occupant situated in the car seat.

2. The universal bicycle mounting apparatus of claim 1, further comprising a plurality of tubular cushion members disposed around the cradle.

3. The universal bicycle mounting apparatus of claim 2, further comprising a U-shaped bracket coupled to the pair of front legs and the pair of rear legs.

4. The universal bicycle mounting apparatus of claim 3, further comprising a first forward bracket comprising a first end coupled to the frame of the bicycle and a second end coupled to one of the pair of front legs, and a second forward bracket comprising a first end coupled to the frame of the bicycle and a second end coupled to another one of the pair of front legs.

5. The universal bicycle mounting apparatus of claim 4, wherein the junctions of the front and rear legs are coupled to rear dropouts of the frame of the bicycle.

6. The universal bicycle mounting apparatus of claim 5, wherein each rear spring of the pair of rear springs comprises a first natural height and each front spring of the pair of front springs comprises a second natural height, wherein the first natural height is greater than the second natural height.

7. The universal bicycle mounting apparatus of claim 6, wherein each front spring in the pair of front springs comprises an upper washer coupled to a top of the front spring and a lower washer coupled to a bottom of the front spring, and a bolt disposed therethough an eyebolt coupled to the cradle, the upper and lower washers of the front spring and one of the pair of front legs.

8. The universal bicycle mounting apparatus of claim 7, wherein each rear spring in the pair of rear springs comprises an upper washer coupled to a top of the rear spring and a lower washer coupled to a bottom of the rear spring, an upper bolt disposed therethough another eye-bolt coupled to the cradle and the upper washer of the rear spring, and a lower bolt disposed therethrough the lower washer of the rear spring and one of the pair of rear legs.

9. The universal bicycle mounting apparatus of claim 8, wherein each rear spring in the pair of rear springs comprises a strap coupled to the upper and lower washers of the rear spring.

10. The universal bicycle mounting apparatus of claim 9, further comprising a first fastening belt coupled to one of the pair of front springs and one of the pair of rear springs and a second fastening belt coupled to another one in the pair of front springs and another one in the pair of rear springs, wherein the first and second fastening belts are configured to secure the infant car seat to the cradle.
